(19) United States
(12) Patent Application Publication
(10) Pub. No.: US 2019/0126295 A1
(43) Pub. Date: May 2, 2019

(54) SPRAY HEADS

(71) Applicant: KOHLER MIRA LIMITED, Cheltenham (GB)

(72) Inventors: Gary KINGTON, Cheltenham (GB); Simon BROWNING, Cheltenham (GB)

(21) Appl. No.: 16/098,791

(22) PCT Filed: Mar. 10, 2017
(86) PCT No.: PCT/GB2017/050643

§ 371 Date: Nov. 2, 2018

(30) Foreign Application Priority Data
May 4, 2016 (GB) 1607824.8

(51) Int. Cl. B05B 1/16; B05B 1/18

(52) U.S. Cl. CPC B05B 1/16; B05B 1/18

(57) ABSTRACT

This invention provides a spray head (110b) for a shower comprising a spray plate (124) having an apertured portion (124a) and an actuator portion (124b). The apertured portion has (124a) apertures (126) therein. The actuator portion (124b) is configured to be actuated by a user to change a spray pattern provided by the apertures of the apertured portion.

### CROSS-REFERENCE TO RELATED PATENT APPLICATIONS

This application is a U.S. National Stage of International Application No. PCT/GB2017/050643, filed Mar. 10, 2017, which claims priority to and the benefit of United Kingdom Patent Application 1607824.8, filed May 4, 2016, each of which is incorporated herein by reference in its entirety.

### BACKGROUND

This invention relates to spray head and more especially to adjustable spray heads for use in a shower.

Prior art adjustable spray heads often have an aperture spray plate rotatable on the body of the spray head to change the spray pattern of water flowing from the apertures in the spray plate. These spray heads can be difficult to use, especially for elderly or disabled users with reduced manual dexterity and/or eyesight.

There is therefore a need for a spray head which provides improved ease of adjustment.

### SUMMARY

According to one aspect the present invention provides a spray head for a shower comprising a spray plate having an apertured portion and an actuator portion, the apertured portion having apertures therein and the actuator portion being configured to be depressed by a user to change a spray pattern provided by the apertures of the apertured portion.

The spray head may be part of a shower handset, or may be a fixed ceiling- or wall-mounted shower head.

It may be that the actuator portion is configured to operate a spray control mechanism located behind the spray plate to control fluid flow to the apertured portion for changing the spray pattern.

It may be that the spray control mechanism includes a flow plate located behind the spray plate and having holes therein aligned with the apertures in the apertured portion of the spray plate.

It may be that the spray control mechanism is configured to be activated by depression of the actuator portion of the spray plate.

It may be that the spray control mechanism includes a diverter operable in response to depression of the actuator portion of the spray plate to change the spay pattern.

It may be that the actuator portion is integral with, the apertured portion of the spray plate.

It may be that the spray plate is made of a flexible material.

It may be that the actuator portion is arranged to allow switching of the spray pattern each time the actuator portion is depressed.

According to another aspect, the invention provides a method of adjusting the spray pattern of fluid from a spray head comprising a spray plate having an apertured portion and a depressible actuator portion, the method comprising depressing the depressible actuator portion of the spray plate.

### BRIEF DESCRIPTION OF THE DRAWINGS

There now follows by way of example only a detailed description of embodiments of the present invention with reference to the accompanying drawings in which:

FIG. 1 shows a front view of a shower handset according to an embodiment;

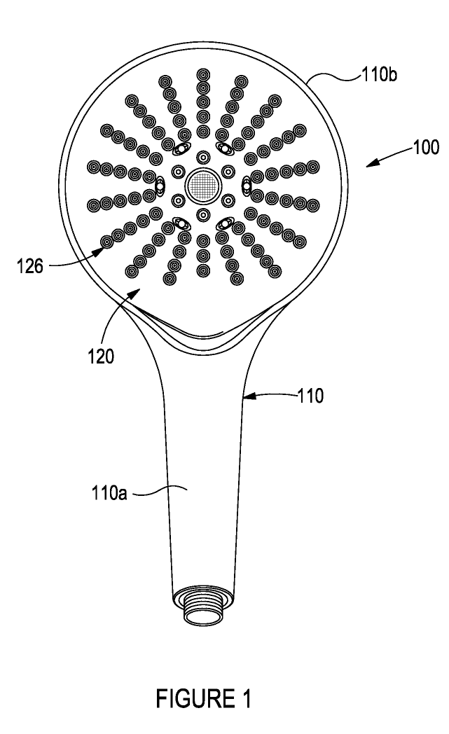

FIG. 2 shows a side view of the shower handset of FIG. 1; and

FIG. 3 shows an exploded view of the shower handset of FIGS. 1 and 2.

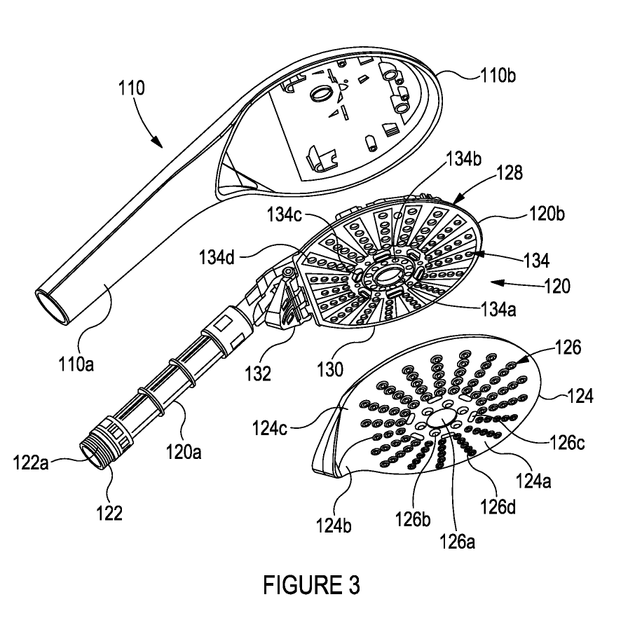

### DETAILED DESCRIPTION

Referring to the drawings, a shower handset 100 is shown. The shower handset 100 comprises a hollow body 110 having a grip portion 110a and a head portion 110b and a spray assembly 120. In this embodiment, the spray assembly 120 has a stem portion 120a and a spray portion 120b. The stem portion 120 is received within the grip portion 110a of the body 110 and has a connector 122 at a first end that extends from the grip portion 110a and has a thread 122a for attaching a water supply such as a flexible hose (not shown). The spray portion 120b is provided at a second end of the stem portion 120a and is located in the head portion 110b of the body 110. The stem portion 120a delivers water to the spray portion 120b. In other embodiments (not shown), the stem portion 120a may be omitted and the grip portion 110a may be connected to the water supply and deliver water to the spray portion 120b.

The spray portion 120b includes a spray plate 124 having an apertured portion 124a and an actuator portion 124b. The apertured portion 124a has a plurality of apertures 126 which define at least two spray patterns.

The spray portion 120b further includes a spray control mechanism 128 located behind the spray plate 124 and operable by the actuator portion 124b to control selectively the supply of water to the apertures 126 in the spray plate 124.

The spray control mechanism 128 includes a flow plate 130 and a switch member 132. The switch member 132 is pivotally connected to the flow plate 130. The spray plate 124 overlies and conceals the flow plate 130 and switch member 132.

The flow plate 130 has a plurality of holes 134 aligned with the apertures 126 in the spray plate 124. The spray plate 124 and flow plate 130 are configured to confine fluid flow through each hole 134 to the aligned aperture 126 and prevent fluid leaking between the spray plate 124 and flow plate 130, For example, the spray plate 124 and flow plate 130 may be configured to seal around each hole 134 and aligned aperture 126.

in this embodiment, the apertures 126 in the spray plate 124 and holes 134 in the flow plate 130 include a central aperture 126a/hole 134a to provide a first spray pattern, an inner array of apertures 126b/holes 134b surrounding the central aperture 126a/hole 134a to provide a second spray pattern, an intermediate array of apertures 126c/holes 134c surrounding the inner array to provide a third spray pattern, and an outer array of apertures 126d/holes 134d surrounding the intermediate array to provide a fourth spray pattern. The central hole 134a in the flow plate 130 may be provided with a mesh to produce a fine spray pattern.

The number, shape and configuration of the apertures 126/holes 134 may be changed to provide any number and/or combination, of spray patterns in other embodiments. Different spray patterns may use entirely separate sets of apertures 126/holes 134. Alternatively, the same apertures 126/holes 134 may be used for more than one spray pattern. For example, in some embodiments, fluid flow through the central aperture 126a/134a may be present in all spray patterns, and/or one spray pattern may use all apertures 126/holes 134.

The actuator portion 124b is located on the circumference of the spray plate 124 and forms a curved protrusion therefrom. The actuator portion 124b may be aligned with the grip portion 110a of the body 110. This may facilitate location of the actuator portion 124b by a user with impaired vision. Alternatively or additionally, the surface of the spray plate 124 may have a different texture in the region of the actuator portion 124b to facilitate its location by a user.

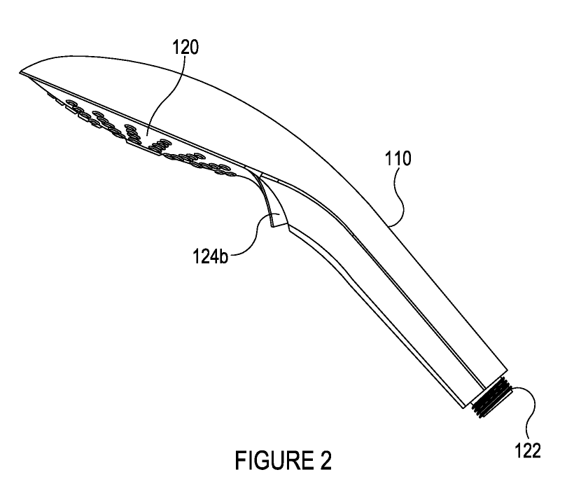

The actuator portion 124b overlies the switch member 132 and is configured to project from the body 110 in its inactive position as best shown in FIG. 2. in use the actuator portion 124b is depressible by a user from its inactive position to an active-position to operate the spray control mechanism via the switch member 132 to change the spray pattern. The switch member 132 may be biased by a spring (not shown) to return the actuator portion 124b to its inactive position when released by the user. Each depression of the actuator portion 124b changes the spray pattern.

The flow plate 130 may comprise channels (not shown) between the back of the flow plate 130 and the head portion 110b of the body 110 that direct flow of water to the holes 134 in the flow plate 130 and the spray control mechanism may comprise a diverter (not shown) operable by the switch member 132 to control the water flow to the channels to change the selected spray pattern or spray patterns in response to activation of the actuator portion 124b.

The spray plate 124 may be flexible. The spray plate 124 may comprise a unitary component. The apertured portion 124a and actuator portion 124b may be integral The spray plate 124 may be configured to allow the actuator portion 124b to be moved relative to the apertured portion 124a. The actuator portion 124b may be connected to the aperture portion 124a by an integral hinge portion 124c of the spray plate 124.

The flow plate 130 may be rigid. The flow plate 130 may be fixed relative to the bead portion 110b of the body 110. The apertured portion 124a of the spray plate 124 may be supported by the flow plate 130. The apertured portion 124a may be fixed relative to the head portion 110b of the body 110.

The invention is not limited to the embodiment described. The spray control mechanism responsive to depression of the actuator portion may be of any suitable construction. The spray plate may be provided with more than one actuator portion.

1-11. (canceled)

12. A spray head for a shower comprising a faceplate having an apertured portion and an actuator portion, the apertured portion having apertures therein and the actuator portion being configured to be depressed by a user to change a spray pattern provided by the apertures of the apertured portion.

13. The spray head of claim 12, wherein the actuator portion is arranged to operate a spray control mechanism located behind the spray plate to control fluid flow to the apertured portion for changing the spray pattern.

14. The spray head of claim 12, wherein the spray control mechanism includes a flow plate located behind the spray plate and having holes therein aligned with the apertures in the apertured portion of the spray plate.

15. The spray head of claim 12, wherein the spray control mechanism is configured to be activated by depression of the actuator portion of the spray plate.

16. The spray head of claim 15, wherein the spray control mechanism includes a diverter operable in response to depression of the actuator portion of the spray plate to change the spray pattern.

17. The spray head of claim 12, wherein the actuator portion is integral with the apertured portion of the spray plate.

18. The spray head of claim 17, wherein the spray plate is made of a flexible material.

19. The spray head of claim 12, wherein the actuator portion is arranged to allow switching of the spray pattern each time the actuator portion is depressed.

20. A shower comprising the spray head of claim 12.

21. A method of adjusting the spray pattern of fluid from a spray head comprising a spray plate having an apertured portion and a depressible actuator portion, the method comprising depressing the depressible actuator portion of the spray plate.
